(19) United States
(12) Patent Application Publication
(10) Pub. No.: US 2017/0253505 A1
(43) Pub. Date: Sep. 7, 2017

(54) MONITORED METHOD FOR IMPROVED IMPAIRED-WATER REMEDIATION

(71) Applicant: Michael T Derzack, Wexford, PA (US)

(72) Inventor: Michael T Derzack, Wexford, PA (US)

(21) Appl. No.: 15/354,498

(22) Filed: Nov. 17, 2016

Related U.S. Application Data
(60) Provisional application No. 62/257,011, filed on Nov. 18, 2015.

(51) Int. Cl. C02F 1/68

(52) U.S. Cl. CPC C02F 1/68; C02F 2103/10

(57) ABSTRACT

The invention is a method of remediating water by adding to a quantity of water to be treated a compound or composition that generates hypohalous acid in situ, followed by addition or generation of ammonia to create an excess of ammonia and in turn to accomplish heretofore unachievable benefits and efficiencies.

### CROSS REFERENCE TO RELATED APPLICATION

This patent application claims priority to, and incorporates herein by reference, U.S. Provisional Patent Application No. 62/257,011, entitled Monitored Method for Improved Impaired-Water Remediation.

### FIELD OF THE INVENTION

The invention is an improved method of clarifying and disinfecting “impaired water,” such as but not limited to flowback and produced water typically found in association with shale oil and gas drilling procedures.

### BACKGROUND OF THE INVENTION

Even though the oil and gas processes surrounding hydraulic fracturing are becoming more and more familiar to the general public, the associated remediation techniques have not yet matured by any means. At the community level, the “fracking” industry would enjoy enormous political stress relief if it could grapple with and objectively solve all the associated environmental concerns. At a chemical level, applicable factors are just as complicated as the community ones: “What in the water needs to be remediated?” “Of which and how much bacteria or other microorganisms does the water need to be disinfected?” “What chemicals might be in the water that no one is expecting?” Compounding the challenge is the reality that impaired waters can vary so widely in composition that identifying protocols suitable for virtually all impaired waters is not straightforward in the least.

So far, much prior attention has been paid to the incorporation of disinfectants in impaired water and, separately, there has been a lot of effort in the area of sequential flocculation of dissolved or colloidal metals and other inorganic materials. However, less attention has been paid to date on controlling the negative consequences of these physical and chemical interventions. Recalling Paracelsus and his fundamental “First, Do No Harm,” the impaired water treatment industry now needs to pay much more attention than before to determining and avoiding the negative consequences of the otherwise necessary flocculation and disinfection protocols. If the water appears clearer and is cleansed of microorganisms but nonetheless contains newly generated toxins or carcinogens, the treatment is of dubious value indeed and thus might well do harm, not good. A need therefore persists for a remediation protocol for impaired water (produced and flowback water, or any impaired water) in which the water can be clarified and disinfected while also affirmatively avoiding the generation of harmful substances in the water that result from many prior art water remediation approaches.

### SUMMARY OF THE INVENTION

In order to meet this need, the present invention is a sequential method of generating hypohalous acid and halamine species in the impaired water, in rapid sequence in that order, together with the use of sensors to monitor water composition to assure at least a 1 ppm excess of ammonia in the water at all times. Ammonia sensors for aqueous systems are widely available for industrial use and are well known in the art. Such a seemingly simple combination of rapid sequence method steps, including the critical ammonia level monitoring, accomplishes the equivalent of a chemical safety net: the generated hypohalous acid and halamine species disinfect the water of all or virtually all microorganisms, whereas the ever-present excess of ammonia prevents the formation of carcinogenic trihalomethanes by converting any excess halogen to halamines by competitive substitution. Halamines are generally harmless to humans, animals and the environment, especially in the low concentrations in which they are generated in flowback and produced water, and in this way the generation of dreadful trihalomethanes is avoided altogether. Moreover, the inventive water remediation method is not limited to produced and flowback water even at the well pad—the present treating sequence can be used with fresh water or with fresh water/impaired water admixtures even in the very first hydraulic injection into a well head—or any other industrial use of hydraulic water, for that matter. The present process is particularly compatible with—and can even enhance the activity of—industry standard friction reducer and scalant additives needed to improve well maintenance and performance, at the same time the invention clarifies the water while preventing formation of unwanted trihalomethanes.

### DETAILED DESCRIPTION OF THE INVENTION

Chemistry from municipal, or even pool-and-spa, traditions of water purification amounts to de facto misdirection when it comes to very impaired water, whether the impaired water is from flowback or produced water or some other polluted source. The real challenge in addressing seriously compromised water lies in part in determining the actual composition of the water—such as the presence of “Naturally Occurring Materials” (NOMs) that inevitably include colloidal metals including iron and other metals, and alkane residues of various length and substitution, such as methane, ethane, etc. In other words, when one is cleaning up really nasty water, one has to take a different approach to remediation than one might in more typical municipal or recreational water management scenario.

The present invention is a sequential water treatment method in which hypohalous acid is first generated in the water, and then that hypohalous acid generation is followed in rapid succession by a monitored titration to at least a 1 ppm excess of ammonia in the water, by adding ammonia or ammonia generating compositions (after adding the ingredient responsible for the hypohalous acid generation and by periodically or constantly monitoring the ammonia levels). The amount of hypohalous acid needed to resolve a given microbial load is known in the art and is not central to the present invention; the invention inheres in the sequential treatment of the water with hypohalous acid, and ammonia, in that order, leaving an excess of ammonia of at least about 1 ppm.

One good way of generating a hypohalous acid in situ, namely, hypochlorous acid, is by the addition of sodium hypochlorite to the water to be treated. Sodium hypochlorite can be purchased commercially as chlorine bleach and is also available as a readily available industrial supply composition. However, any hypohalous acid in the water will perform the same biocidal function, so addition of an appropriate amount of a composition which generates the necessary biocidal function of any hypohalous acid is contemplated by the present invention. The inorganic chemistry of hypohalous acid generation is well known and therefore need not be repeated here. The important thing is that the present invention inheres in the sequential water treatment steps of adding something to the water that will generate adequate hypohalous acid to neutralize the biological load (microbial contents) followed by addition of ammonia—or something that will generate ammonia—to yield excess ammonia of at least 1 ppm to generate halamine species. The remainder of the invention can be practiced with variation as to choice of starting constituents or reactants, as long as the above-described parameters are observed.

For example, water additives that generate ammonia, other than ammonia itself, include ammonia salts such as NH₄Cl, NH₄SO₄, NH₄OH, NH₄Br and any other ammonia salts that generate ammonia upon addition to water. Generation of hypobromous acid, rather than hypochlorous acid, is also well known in aqueous systems and therefore need not be repeated here. Generation of other hypohalous acids is within the skill of the art at this writing.

Optimally, and as a preferred embodiment of the invention, sufficient oxidizer (hypohalous acid generator) is added to achieve free residual halogen, and therefore the supplemental ammonia ideally reaches an optimal level in which a free residual halogen/ammonia ratio of about 3:1 to 10:1 is achieved.

Surprisingly, the practice of this invention proved to be surprisingly compatible with friction reducers and scalants already in use in hydraulic fracturing applications. This compatibility is believed to be attributable to the ability of the oxidizer to sequester colloidal ferric iron and other colloidal metals from the water thereby enhancing the ability of the metals and microorganism solids to flocculate readily, while at the same time the ammonia excess prevents the formation of unwanted compounds (trihalomethanes) which are not only carcinogenic or otherwise unwanted in and of themselves, but which are potentially reactive with the scalants and friction reducers of the prior art due to their nonpolar, cosolvent natures. In other words—it is believed that a side benefit of preventing the formation of trihalomethanes is the preservation of initial alkane residues in the water in their initial unhalogenated state—which are usually if not always free unsubstituted short- chain alkanes susceptible of quick removal from the treated water by simple volatilization upon exposure of the water to the air.

### EXAMPLE

As a real world test, the inventor collected water for analysis from an active hydraulic fracturing well. Directly on the well pad was a tank which stored impaired water (flowback/produced water) only. Isolated in the area was an off-site fresh water only impoundment. Fresh water and impaired water were then blended as 50% fresh water and 50% impaired water in work tanks adjacent to the well head. To each 1000 barrels of water were added about 5 gallons of a known concentration of sodium hypochorite, with mixing, which not only killed the entire microbial load of the specific water being treated but which also precipitated out all cloudiness, presumably due to the generated hypochlorous acid's sequestering the colloidal ferric iron from the water and allowing it to precipitate along with the no-longer-viable microorganism solids. Immediately after the addition of the sodium hypochlorite, ammonia was added to achieve a 5:1 molar concentration, respectively. At the work tank an ammonia sensor was placed to monitor ammonia levels in the water. As needed, additional ammonia was added to keep the excess ammonia level in the water at 1 ppm.

Although the invention has been described with respect to particular methods and constituents, above, the scope of the invention is only to be limited insofar as is set forth in the accompanying claims.

I claim:

1. A method of remediating water, comprising adding to a quantity of water to be treated a compound or composition that generates hypohalous acid in situ upon addition to water, followed by addition or generation of ammonia to create an excess of ammonia in the amount of at least 1 ppm in said quantity of water to be treated.

2. The method according to claim 1, wherein said compound or composition that generates hypohalous acid is sodium hypochlorite and said hypohalous acid is hypochlorous acid.

3. The method according to claim 2 wherein said ammonia excess is monitored by an ammonia sensor.

4. The method according to claim 3 wherein ammonia monitoring takes place over time.

5. The method according to claim 4 wherein said compound or composition that generates hypohalous acid is added to achieve free residual halogen and further wherein ammonia added thereafter causes the water to reach a free residual halogen/ammonia ratio of about 3:1 to 10:1.
